(19) United States
(12) Patent Application Publication
(10) Pub. No.: US 2010/0057548 A1
(43) Pub. Date: Mar. 4, 2010

(54) TARGETED CUSTOMER OFFERS BASED ON PREDICTIVE ANALYTICS

(75) Inventor: Duane S. Edwards, Seattle, WA (US)

Correspondence Address: DARBY & DARBY P.C., P.O. BOX 770, Church Street Station, New York, NY, 10008-0770, US

(73) Assignee: Globy's,Inc., Seattle, WA (US)

(21) Appl. No.: 12/546,449

(22) Filed: Aug. 24, 2009

Related U.S. Application Data
(60) Provisional application No. 61/092,304, filed on Aug. 27, 2008.

(51) Int. Cl. G06Q 30/00; G06Q 10/00; G06Q 50/00

(52) U.S. Cl. 705/14.13

(57) ABSTRACT

Embodiments are directed towards enabling product and/or service providers to maximize sales of products, services, and content to their existing customers. In one embodiment, a process, apparatus, and system are directed towards optimizing a selection of offers for any customer touch-point to ensure the provider delivers the best offer to the right customer at the most appropriate time. Offers are optimized not only according to a customer's interests and preferences but also according to revenue and profitability potential using predictive analytics.

### CROSS-REFERENCE TO RELATED APPLICATIONS

This application claims the benefit of U.S. Provisional Application Ser. No. 61/092,304 entitled “Targeted Customer Offers Based On Predictive Analytics,” filed on Aug. 27, 2008, the benefit of the earlier filing date of which is hereby claimed under 35 U.S.C. §119(e) and which is further incorporated herein by reference.

### TECHNICAL FIELD

The present invention relates generally to providing targeted customer offers and, more particularly, but not exclusively to using predictive analytics to maximize product offerings to customers in, for example, but not exclusively, a telecommunications market.

### BACKGROUND

The dynamics in today's telecommunications market are placing more pressure than ever on carriers to find new ways to compete. As the competitive landscape has become more intense, carriers have largely been focused on top line growth and capacity building. To attract new customers and maximize revenue from existing customers they have found themselves implementing high-cost broad-swath campaigns and incentives with minimal attention to profitability. As voice revenue has declined, there has been a proliferation of new products, services, and content. And yet, while carriers typically accumulate vast amounts of complex data about their customers they often make limited strategic and tactical use of it.

To effectively monetize their customer base and maximize revenues, carriers have become increasingly interested in how they can leverage customer analytics to ensure that the best offer is presented to the right customer at the most appropriate time across any channel.

Based on in-depth subscriber intelligence and rich customer profiles, some carriers are beginning to realize that an offer optimization solution can enable targeted selection and delivery of more relevant products, services, and content to individual customers, optimize the user experience, drive higher average revenue per user (ARPU), and reduce churn. Carriers who are successful will also enhance their relationships with content partners by becoming a better channel and ultimately secure their long-term position in the off-deck mobile Internet-based advertising value chain. However, few carriers are currently able to determine how to go about such efforts. Having the data does not necessarily translate into an optimized solution for the carrier and/or the customer. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention; and

FIG. 4 shows one embodiment of an offer optimization architecture useable to generate customer offers;

FIG. 5 illustrates one embodiment of a non-exhaustive, non-limiting example of a table of calculations useable to determine an optimal offer; and

FIG. 6 illustrates a logical flow diagram generally showing one embodiment of a process of determining and providing an optimized offer to a customer.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “customer” refers to virtually entity that has or may in the future make a procurement of a product and/or service from another entity. As such, customers mean not just an individual but also businesses, organizations, or the like.

As used herein, the terms “optimized,” and “optimal,” refer to a solution that is determined to provide a result that is considered closest to a defined criteria or boundary given one or more constraints to the solution. Thus, a solution is considered optimal if it provides the most favorable or desirable results, especially under some restriction, compared to other determined solutions. An optimal solution therefore, is a solution selected from a set of determined solutions.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards enabling operators to maximize sales of products, services, and content to their existing customers. In one embodiment, a process, apparatus, and system are directed towards providing a customer with the offer, out of a selection of potential offers that will generate the most revenue or profit for the operator. The offer is determined as a best offer to be presented to a customer, in one embodiment, where the offer is determined to maximize long-term financial benefits to at least an operator. Thus, in one embodiment, rather than merely providing the customer with an offer that might have a determined highest likelihood of being accepted by the customer (e.g., being purchased), the offer is selected among other determined offers by taking into account a long-term financial impact of the offer. For example, a present value of expected revenues and/or profits to the operator may be included in determining the best or optimal offer. In one embodiment, an offer might be determined as an optimal or best offer among a set of determined offers where the offer maximizes both a purchase likelihood by a customer and maximizes the financial impact or benefit to the operator.

In one embodiment, channel-specific time-based penalties may be employed to control a frequency and/or timing in which a particular offer might be presented to a customer. Thus, in one embodiment, differences might be allowed in a frequency in which an offer is presented based on the channel, as well as other criteria. For example, offers might be presented at one frequency when the channel is an online communication and at a different frequency when the channel is, for example, a telephone conversation with the customer. Unlike more traditional mechanisms, which might present offers using a rules-based manner, embodiments of the invention instead may apply various penalties based on a channel, and/or even a type of product/service being offered. For example, where traditional rules might wait three days before presenting an offer again, embodiments of the invention might apply a decaying penalty criteria that may be different for different channels. Thus, for example, an offer might be presented during telephone conversations with the customer so as to decrease the number of times the offer is presented over time, based on a number of telephone conversations, duration between telephone conversations, durations of a given telephone conversation or the like. Where the channel is, for example, an online channel such as being displayed on a screen of a client's computer device, the offer might be presented using a decaying penalty, such that the number of times the offer is re-presented to the customer decreases in frequency over time. However, in still other embodiments, offers that may be considered as strong offers, having, for example, a larger financial impact or benefit to an operator, being time sensitive offers, or the like, might receive yet another frequency of repeating the offer to the customer over another offer considered to be a weaker offer.

In another embodiment, a context in which an offer may be presented is also factored into each of the determined offers from which a best or optimal offer may be selected. Thus, a location of a customer, a time of day, or the like, may be employed by a predictive model providing a determined weighting for the offer, channel, customer, and the like.

In one embodiment, a plurality of different predictive models may be employed for a given customer. In this manner, an optimal offer might be selected from across different predictive models. In still another embodiment, different predictive models may be employed across different customers to further select a predictive model that is determined to provide more consistent optimal results for given constraints over another predictive model.

Although the invention is described for use by telecommunication providers, the invention is not so limited. Thus, for example, other market products, such as vehicles, vehicle add-ons, client computing devices, eyewear, or virtually any other marketable product space may employ embodiments of the invention, without departing from the scope of the invention.

### Illustrative Operating Environment

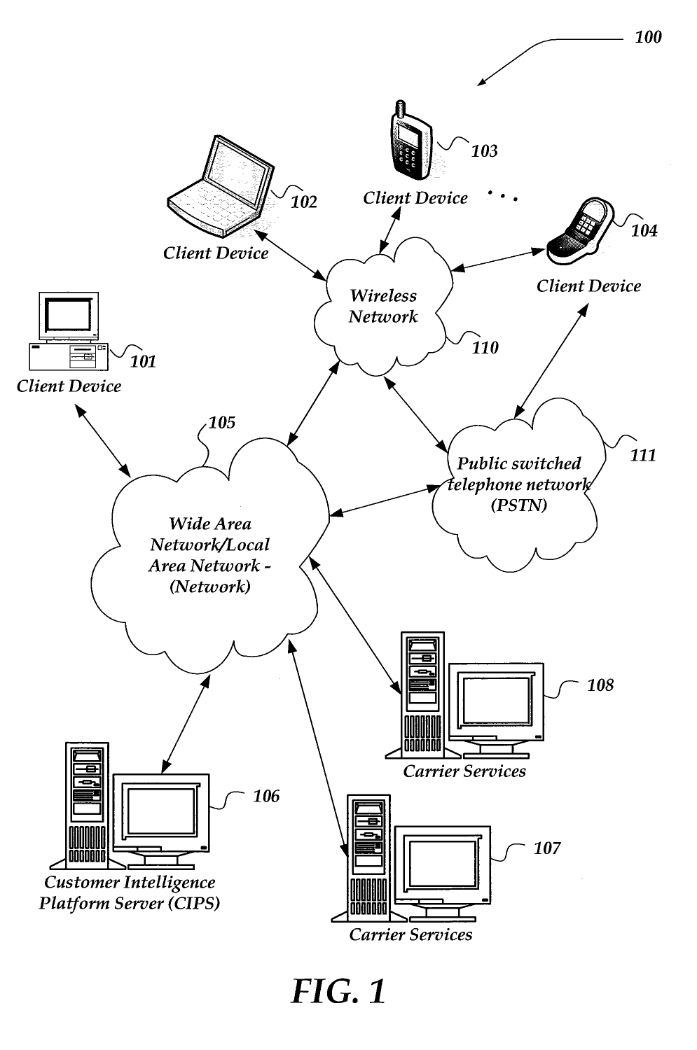

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Public Switched Telephone Network (PSTN) 111, client devices 101-104, Customer Intelligence Platform Server (CIPS) 106, and carrier services 107-108.

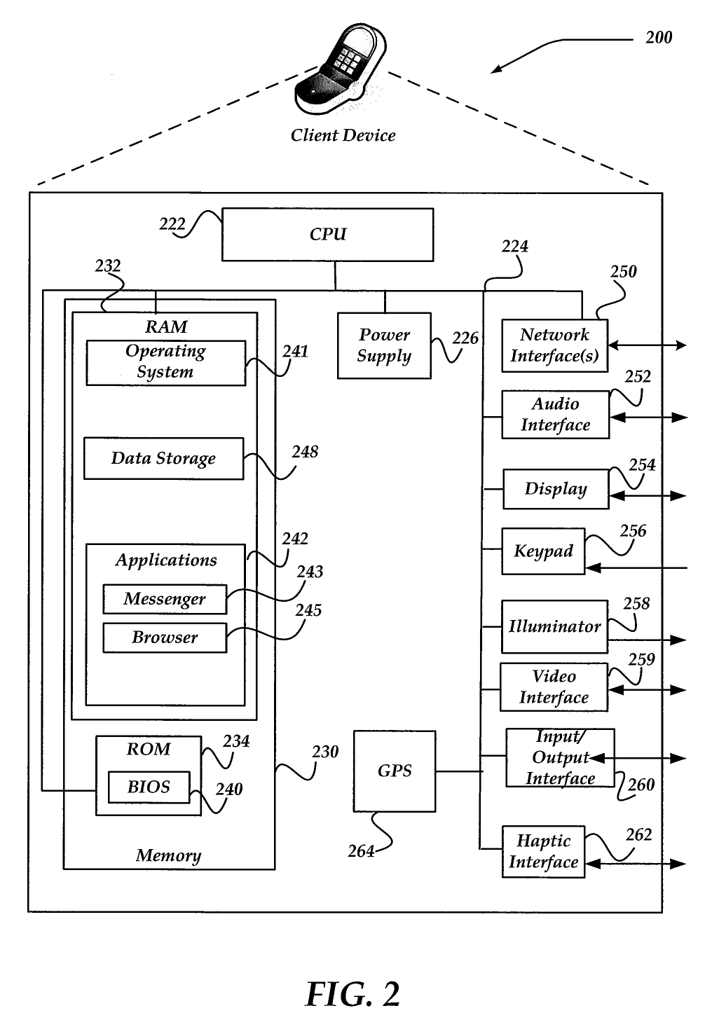

One embodiment of a client device usable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device. Information provided either as part of a user account generation, a purchase, or other activity may result in providing various customer profile information. Such customer profile information may include, but is not limited to demographic information about a customer, and/or behavioral information about a customer and/or activities. In one embodiment, such customer profile information might be obtained through interactions of the customer with a brick-and-mortar service. However, customer profile information might also be obtained by monitoring activities such as purchase activities, network usage activities, or the like, over a network.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

PSTN 111 is configured to include any of a variety of wired and wireless technologies arranged to provide circuit-switched telephony services to various client devices, including, but not limited to client device 104, as well as to fixed location telephone devices. PSTN 111 may include fixed-line analog components, as well as digital components that enable communication between mobile client devices (such as client device 104) and/or fixed telephone client devices. Thus, PSTN 111 may enable telephony services to be provided between client devices 101-104 and carrier services 107-108, and/or to CIPS 106.

Network 105 is configured to couple CIPS 106, carrier services 107-108, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

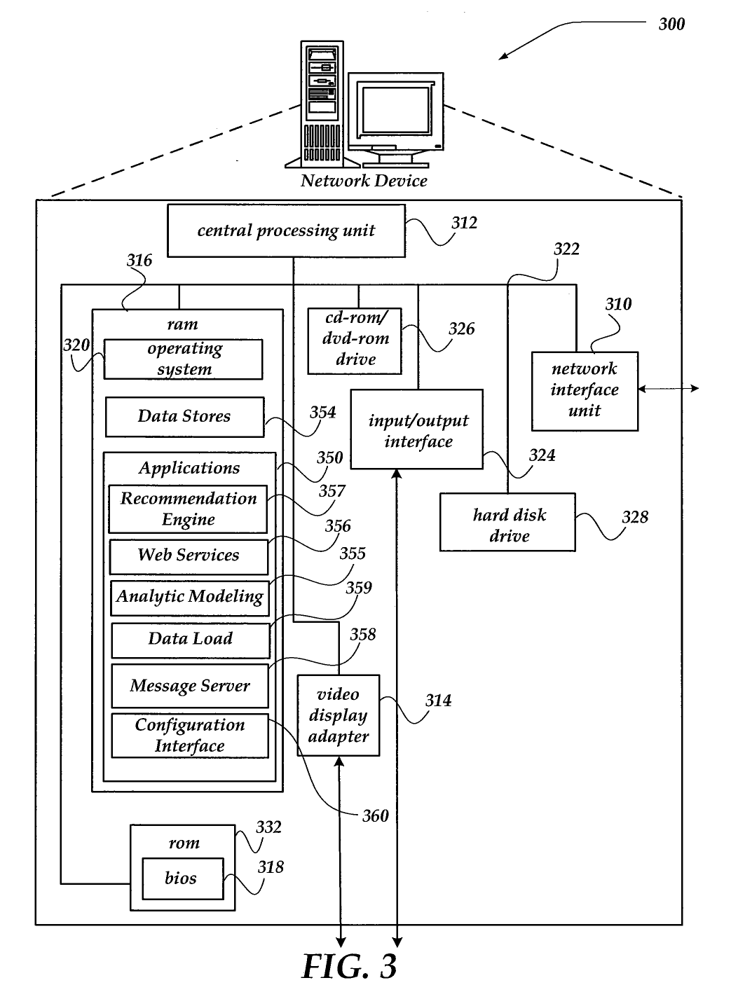

CIPS 106 includes virtually any network computing device that is configured to provide predictive analytics to target offers to customers, as described in more detail below in conjunction with FIGS. 3-6.

Devices that may operate as CIPS 106 include, but are not limited to personal computers, desktop computers, multiprocessor systems, microprocessor-based or programmable consumer electronics, network PCs, servers, network appliances, and the like.

Although CIPS 106 is illustrated as a distinct network device, the invention is not so limited. For example, a plurality of network devices may be configured to perform the operational aspects of CIPS 106. For example, profile data collection might be performed by one or more set of network devices, while predictive analytics, and/or reporting interfaces, and/or the like, might be provided by another one or more network devices.

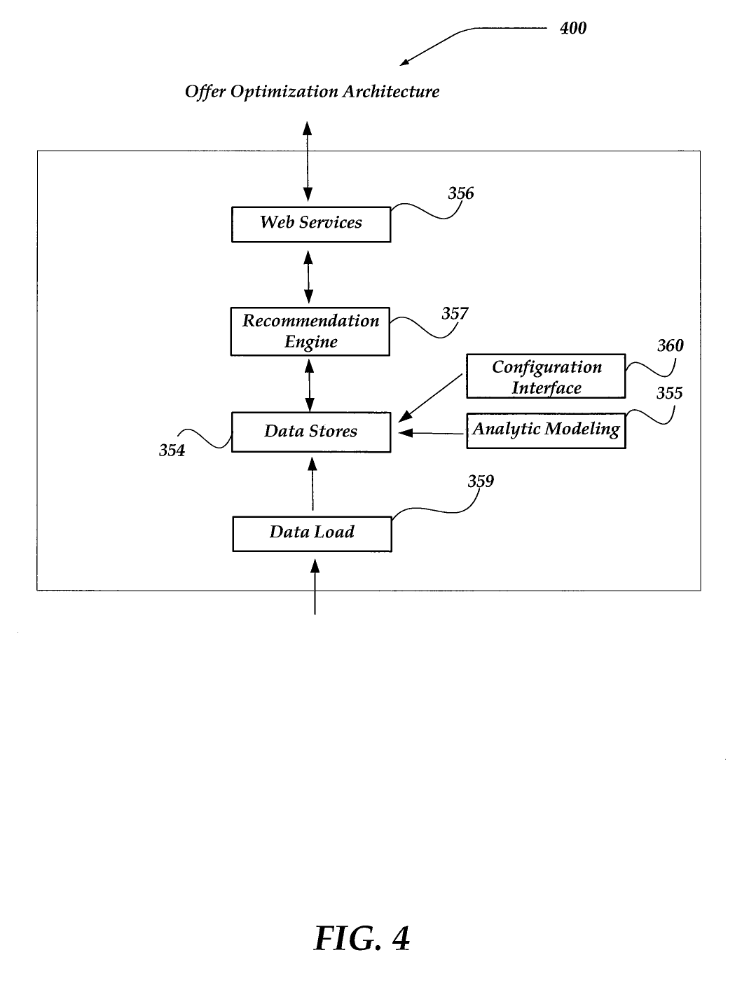

Carrier services 107-108 include virtually any network computing device that is configured to provide operator, customer, and other context information useable by CIPS 106 for use in generating targeted customer offers. Thus, carrier services 107-108 may provide various interfaces, including, but not limited to those described in more detail below in conjunction with FIG. 4. It should be noted, that while carrier services 107-108 are illustrated as providing services for telecommunications, the invention is not so limited, and other products and/or service providers may be represented by carrier services 107-108, without departing from the scope of the invention. Thus, for example, in one non-exhaustive embodiment, carrier services 107-108 might represent a financial institution, an educational institution, merchant sites, or the like.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Moreover, client device 200 may be configured to communicate using public circuit-switched telephone services, as well. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, user demographic information, behavioral information, or the like. At least a portion of the information may also be stored on a disk drive or other storage medium (not shown) within client device 200.

Applications 242 may include computer executable instructions which, when executed by client device 200 on one or more processors, such as CPU 222 perform actions, including, but not limited to transmitting, receiving, and/or otherwise processes messages (e.g., SMS, MMS, IM, email, and/or other messages), multimedia information, and enable telecommunication with another user of another client device, and performing other actions. Other examples of application programs include calendars, browsers, email clients, IM applications, SMS applications, VOIP applications, PSTN interface applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed. In any event, browser 245 may be used to enable a user to participate in an online matching service.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, CIPS 106 or carrier services 107-108 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, a PSTN, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about members to a social networking activity, contact lists, identifiers, profile information, tags, labels, or the like, associated with a user, as well as scripts, applications, applets, and the like.

One or more applications 350 may be loaded into mass memory and run on operating system 320 within one or more processors, such as central processing unit 312, to cause central processing unit 312 (and therefore, network device 300) perform actions. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, analytic modeling 355, data load 359, and recommendation engine 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 interacts with recommendation engine 357 to retrieve a targeted offer for a customer and communicate the offer back to the network device that requested the offer such as carrier services 107-108 of FIG. 1.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types. In one embodiment, message server 358 may also be configured to interact with recommendation engine 357 and/or web services 356 to provide various communication and/or other interfaces useable to receive operator, customer, and/or other information useable to determine and/or provide targeted customer offers. Thus, message server 358 and/or web services 356 may provide one or more offers to a customer (user) of at least client devices 101-104 of FIG. 1. However, such offers may also be presented to a customer using any of a variety of other mechanisms, including, for example, presenting an offer onto a display screen of an operator or the like, such that the operator may verbally read the offer to the customer over a telephone, or other mechanism.

Analytic modeling 355 is described further below. However, briefly, analytic modeling 355 is configured and arranged to build predictive models that may then be utilized by the recommendation engine 357.

Data load 359 is described further below. However, briefly, data load 359 is configured and arranged to extract, transform, and load (ETL) incoming customer data and store the data in data stores 354.

Configuration interface 360 is described further below. However, briefly, configuration interface 360 is used by an operator of the system to define how the system is configured.

Recommendation engine 357 is described further below. However, briefly, recommendation engine 357 is configured and arranged to employ predictive analytics to generate optimized product and/or service recommendations.

### Illustrative Offer Optimization Architecture

FIG. 4 shows one embodiment of an offer optimization architecture useable to generate customer offers. Architecture 400 of FIG. 4 may include more components than those shown. The components shown, however, are sufficient to disclose an illustrative embodiment for practicing the invention. Architecture 400 may be deployed across components of FIG. 1, including, for example, CIPS 106, and/or carrier services 107-108.

As illustrated, the components of architecture 400 represent at least some of the components mentioned above in conjunction with FIG. 3. Thus, architecture 400 includes, web services 356, recommendation engine 357, data stores 354, configuration interface 360, analytic modeling 355, and data load 359.

Web services 356 is configured to include one or more ‘background applications’ that are configured to process requests for a targeted customer offer that may be received from a network device such as carrier services 107-108 of FIG. 1. In one embodiment, the network device requests the offer from web services 356 when there is an opportunity to present a customer with an offer such as but not limited to when the customer places a call to a call center that may be managed within and/or by carrier services 107-108; when the customer logs into a web portal or online billing application such as may also be managed through carrier services 107-108; when the customer visits a mobile deck or mobile storefront, when the customer is sent a paper bill; when the customer is called by an outbound marketing representative or system; or when a direct marketing piece is sent to the customer.

The request to web services 356 must include a unique identifier for the customer such as their customer identifier or account number, the phone number of the customer, and an identifier for a type of network device making the request, which may be referred to as the channel through which the offer is being made. Channels thus, might include but are not limited to various communication mechanisms that are employed with the customer such as audio telephone call, web page communication such as displaying the offer on a screen of the customer's client computer device, physical paper communications, or the like. Thus, one or more channels for communicating an offer include a physical mechanism for communicating the offer, thereby transforming the offer into a physical entity. It should be recognized, moreover, that one or more of the offers may include offers for purchase of physical entities, as well. The request may also include optional context-related attributes such as the location of the customer as represented by latitude and longitude or some other means, the current time for the customer, the language of the customer, and the catalog of offers to utilize.

When a request is received, web services 356 communicates with recommendation engine 357 which makes a determination of the offer that, in one embodiment, will generate the most revenue or profit for the operator. However, in other embodiments, recommendation engine 357 may select a best offer best on other criteria, including, but not limited to offers that are determined to maximize long-term financial benefits to at least one operator, maximizes both a purchase likelihood by a customer and the financial impact or benefit to the operator, or maximizes some other defined criteria. In any event, after that determination is made, the recommendation engine 357 returns the offer to web services 356 which in turn returns the offer to the network device that requested the offer, in one embodiment. However, in another embodiment, web services 356 might be configured to present the offer directly to a customer using a browser interface on a client device.

Recommendation engine 357, upon receiving a request for an offer from web services 356, determines if the customer for whom the offer is intended has been assigned a classification for a model to use to determine the optimal offer. If the customer has not been assigned to a model classification, the customer may, in one embodiment, be randomly assigned to a model classification using a configured weighting for each model classification so that some model classifications may have larger groups of customers and other model classifications have smaller groups of customers. However, the invention is not limited to randomly assigning a customer to a model classification, and other schemes may also be used. For example, in one embodiment, a customer might be assigned to a model classification based on historical data about the customer that might be obtained from a carrier service. For example, a customer might be assigned to one model over another based on a type of equipment the customer has purchased for communications over a previous defined time period, type of purchases the customer typically makes for telecommunication's services; or the like. In another embodiment, a customer might be assigned to a model classification based on various characteristics of the customer that may be obtained from a carrier service, or other source. For example, a customer might be assigned to a model classification based on a physical location of the customer, an educational level of the customer, an income level; or virtually any other criteria. Thus, in one embodiment, customers may be assigned to a model classification based on selected common characteristics. In another embodiment, customers may be randomly assigned to ensure a reasonably unbiased distribution of customer characteristics, across the models. In any event, model classifications for customers are stored in data stores 354.

The model classification is used to test different approaches for determining an optimal offer by comparing acceptance rates for each offer across the model classifications. For example, an offer for one product may have a 5% acceptance rate when model A is used and a 7% acceptance rate when model B is used. This might suggest that model B is a better approach for the offer. If, in this example, model B is consistently better than model A across a variety of offers, the weightings and customer assignments may be changed to use model B for a larger percentage of customers, or to use model B, exclusively, for a given carrier service, given time period, or based on some other criteria.

The model classifications utilized typically include various predictive models but can also include non-predictive models. Non-limiting, non-exhaustive examples of types of predictive models that may be used include but are not limited to statistical regression models, decision trees, neural networks, Bayesian classifiers, graphical models, survival models, pattern recognition statistical methods, and the like. Thus, as noted above, model A might be selected from one of these types of predictive models, while model B might be selected from one of the other types of predictive models. However, in another embodiment, model A, in the example, above, might be a predictive model, while model B might be selected from one of a variety of non-predictive models. In one embodiment, non-predictive models may return a completely random offer or utilize a configured weighting to determine a random offer. A non-predictive model could be used for customers that have chosen to opt out of predictive models such as customers that have requested that their data not be used for marketing purposes as well as to compare the acceptance rates of predictive models to that of non-predictive models. Multiple models of a particular type may also be used. For example, two statistical regression models may be used simultaneously to determine a best offer. Moreover, as noted above, several different models might be used to provide a plurality of different offer results, from which a best offer might be selected from one of these offer results.

Configuration interface 360 provides an interface that may be used by an operator of the architecture 400 to define the model classifications and/or a percentage of customers that are to be assigned to each model classification, and/or any other criteria for assigning customers to various model classifications. In one embodiment, criteria, model parameters, and/or other definitions of the model classifications are stored in data stores 354 and can be entered directly into data stores 354 with, or without using the configuration interface 360.

Configuration interface 360 can also be used by an operator of the architecture 400 to define the available offers. Each offer may have a set of attributes such as its name, its description, a unique tracking identifier for the offer, a Universal Resource Locator (URL) for a graphic associated with it, a script to read to the customer based on an offer, a click-thru URL for more information on an offer, an offer's start date, an offer's end date, an offer's projected revenue, and an offer's projected profit for a given operator. Configuration interface 360 can also be used to specify various components of the offer such as but not limited to the products, services, features and/or content that comprise the offer. An offer may include multiple components such as one or more products and/or one or more services and/or one or more features and/or one or more pieces of content. An offer may also include additional components that are not described as products, services, features, or content. The definitions of the offers and associated components of the offer are stored in data stores 354 and can be entered directly into data stores 354 with, or without using the configuration interface 360.

Configuration interface 360 can also be used by an operator of the architecture 400 to define rules that control whether or not a given customer is eligible to receive an offer. For example, in one embodiment, one type of rule may indicate whether the customer has, doesn't have, exceeds, or doesn't exceed a particular attribute or value. In one non-limiting, non-exhaustive example, the rule may specify that the customer must live in a particular city, cannot be within a particular age range, must have a credit score over a particular value, and/or must be under a particular age. Another type of rule may relate to the products, services, features, and content currently or in a defined prior time period that are/were determined to be used by the customer. For example, the rule may specify that a customer must use a particular product to receive an offer and/or cannot use a particular service to receive an offer. Other types of rules may also be used. Thus, the invention is not to be construed as being limited by these non-exhaustive examples. The definitions of the rules associated with offers are stored in data stores 354 and can be entered directly into data stores 354 with, or without using the configuration interface 360.

Configuration interface 360 can also be used by an operator of the architecture 400 to define the parameters and weights of the model for each combination of model classification and offer. These parameters can be determined by a statistical modeler using analytic modeling 355 and data stores 354, or by an automated system for analytic modeling 355 using data stores 354. The statistical model or automated system may employ attributes of customers and information related to customers' purchases of products, services, features, and content to determine the parameters to use for each model for each offer. For example, if statistical analysis shows that a particular product is purchased more by men than women and is purchased more by younger customers, a logistic regression model may be generated that determines a probability that a customer will accept an offer with greater weights for the customer attributes of gender and age and lesser or no weights for other customer attributes such as credit score, income level, education level, or address. The models may also incorporate contextual information such as the channel through which the offer is to be made, the current location of the customer as represented by latitude and longitude or another means, the current time of day for presenting the offer to the customer, and/or other contextual information. Weights can be used to skew the results of a model in a particular direction based upon marketing objectives. For example, a new product that is being heavily promoted may be weighted slightly higher than an older product that is generally well known and less heavily promoted. The definitions of the model parameters and weights are stored in data stores 354 and can be entered directly into data stores 354 without using the configuration interface 360.

Configuration interface 360 can also be used by an operator of the architecture 400 to define the channels through which a customer may receive an offer. Examples of channels include but are not limited to call center applications, interactive voice response (IVR) systems, web portals and online billing applications, mobile decks, storefronts, bill inserts, and direct marketing systems. Each channel can have its own time-based penalty that limits the same offer from being presented again within a particular amount of time. For example, in an online billing application, it may be acceptable to see the same offer multiple times within a few minutes. However, when speaking to a representative in a call center, an offer may only be presented once or once every couple of months. The definitions of the channels are stored in data stores 354 and can be entered directly into data stores 354 with, or without using the configuration interface 360.

Data load 359 takes data from various sources and extracts, transforms, and loads (ETL) it into data stores 354. Customer data that may be used includes but is not limited to customer profile data, customer billing data, and customer usage data. Data load 359 generates customer attributes by performing actions including but not limited to aggregating, calculating, storing, and converting data. As a result, a profile is built for each customer that may include demographic, behavioral, and psychographic information as well as current and past products, services, features, and content utilized and/or purchased by the customer.

After determining the model classification for the customer, recommendation engine 357 retrieves from data stores 354 the current offers for which the start date of the offer has passed and the end date is still in the future. If a catalog is specified in the request to web services 356, only current offers associated with the catalog will be retrieved.

Recommendation engine 357 also retrieves from data stores 354 the model parameters for each offer and the profile of the customer. The model parameters and customer profile are then used to eliminate offers for which the customer is not eligible and to evaluate the probability of acceptance by the customer for each offer.

Each offer may, in one embodiment, be scored by multiplying the probability of acceptance, the weight of the offer for the model, the penalty for the channel, and the projected revenue or profit associated with the offer. The probability of acceptance may be calculated, in one embodiment, for each available offer using one or more unique profile attributes of the customer and/or the customer's context. The weight of each offer may be optional. Weighting may be used, however, when an operator wants to emphasize a particular offer, even if that offer might not be an otherwise optimal or best offer based on a customer's criteria. This may be used, for example, when the operator is promoting a new product and wants to increase customer exposure to the product. The weighting may be, in one embodiment, specific to a model. Thus, one model might employ weighting, while another model might not employ weighting.

In one embodiment, the penalty for the channel utilizes a time elapsed since the offer was previously presented to the customer in the channel (e.g., the amount of time since it was last presented online or the amount of time since it was last presented over the phone) to prevent an offer from being presented too frequently. Since a customer's reaction to receiving a duplicate offer may differ from one channel to another channel, a penalty may be defined by a given channel. For example, it might be determined to be acceptable to a customer to receive the same offer multiple times within a minute while online but not acceptable to receive the same offer multiple times within a month over the phone. The penalty may also decrease over time so it has more impact immediately after an offer is made and less impact as time goes on. As a result, a very strong offer may “overcome” the penalty and be shown relatively soon after being presented previously. However, in other embodiments, the penalty might be based on other schemes, including, for example, by increasing over time the penalty.

In one embodiment, the projected revenue or profit associated with an offer is the present value of expected future revenue and/or profit expected from the customer if the offer is accepted. Some operators may select to focus on just revenue, others may select to focus on just profit, and others may select to utilize a combination of both. Operators may also select to have some offers focus on just revenue, other offers focus on just profit, and other offers utilize a combination of both. The incorporation of projected revenue or profit ensures that the solution maximizes the long-term financial impact for the operator by delivering offers that take into account both the probability of acceptance and the expected financial benefit (as well as operator-defined weighting and penalties for offers previously presented).

As shown, then the offer with the highest score after the multiplication is performed is selected by recommendation engine 357 as the optimal offer and the details of the offer are retrieved from data stores 354 and returned to web services 356 which returns them to the network device that requested the offer.

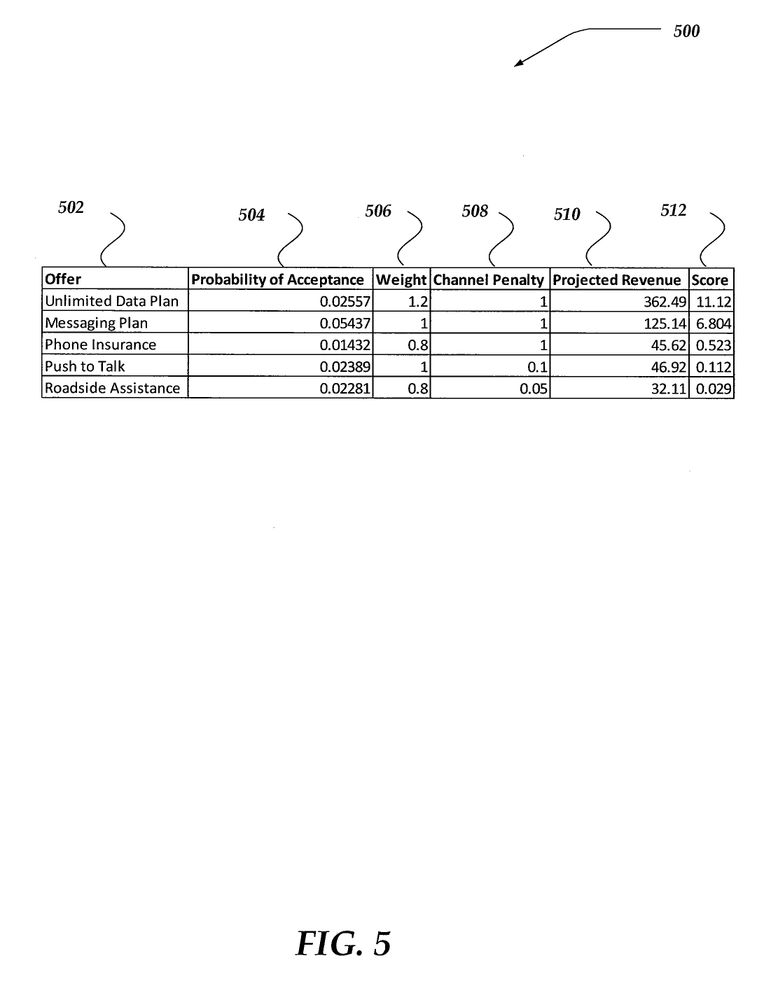

FIG. 5 illustrates a non-limiting, non-exhaustive example of calculations utilized to determine the optimal offer. Table 500 of FIG. 5 may include more or less components than are shown. The components shown, however, are sufficient to disclose one embodiment for practicing the invention. As shown, table 500 illustrates for a given operator and customer, various offers 502, probability of acceptance (of an offer by the customer) 506, applied weights 508, channel penalty 510, projected revenue 512, and resulting scores 514.

As shown, each offer may have an associated probability of acceptance by the customer based on various information about the customer and further based on the model classification of the customer, as well as other criteria, as described above. Weights 508, as described above may be optional, to emphasize one offer over another offer, while channel penalty 510 is directed towards penalizing a particular offer over another offer. Thus, channel penalty 510 might, in another embodiment, include a plurality of values (not shown) for a given offer, each value indicating a different penalty for a different channel. Thus, for example, for offer 502 “unlimited data plan,” instead of a single penalty, different penalties might be used, such as 0.1 for telephone channels, 0.7 for paper channels, 0.05 for web page channels, or the like. However, offer 502 “push to Talk” might include different penalties, such as 0.05 for telephone channels, and 1 for paper channels, or the like. Thus, different penalties 510 may be applied for different channels for different offers 502. However, in another embodiment, a particular offer 502 might have a constant penalty 510 applied no matter which channel is employed to present that offer. In still another embodiment, a part of the request for a best or optimal offer, the carrier service might indicate to which channel to limit a determination of the optimal offer. Thus, in one embodiment, a single channel penalty 508 might indicate that the channel is a preselected or identified channel for which the offer is to be provided.

Projected revenue 512 may, in one embodiment, represent a present value of expected revenues and/or profits to the carrier service for a given offer 502. In another embodiment, projected revenues 512 may also represent values indicating a long-term financial benefit to the carrier service. Such values may be provided by the carrier service themselves for each offer, service, combination of services, or the like. In another embodiment, sub-values might be provided to the model, wherein the model further computes the projected revenue 512 for each offer 502.

As noted above, scores 514 may then be a result of employing the model to combine each of the above-mentioned input to identify an offer that may be a best offer among available offers. Such best offer may be based, for example, on the offer that maximizes both a purchase likelihood by a customer and the financial impact or benefit to the operator. However, based on the weights, channel penalty, or the like, the best offer may be that offer 502 with a highest score indicating that for a given time period, for a given channel, a given offer 502 provides a maximized long-term financial benefit to the carrier service. However, as noted, other criteria may be used within a given model to identify the best or optimal offer 502 among the set of identified offers. As shown, for example, in table 500, the offers 502 are rank ordered by scores 514, wherein the first illustrated offer 502 “unlimited data plan” is indicated for the employed model, and given the constraints (weighing, channels, customer information, and the like), is determined to be the optimal or best offer among offers 502.

### Generalized Operation

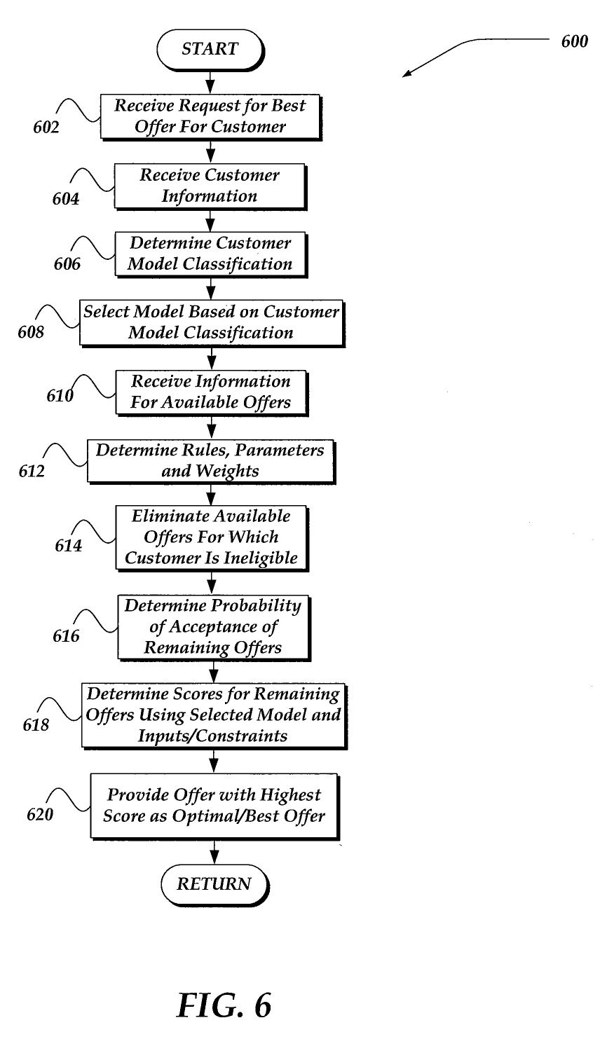

The operation of certain aspects will now be described with respect to FIG. 6. As noted above, process 600 of FIG. 6 may be implemented within Architecture 400 of FIG. 4, and one or more of network device 300, such that one or more processors may perform the actions of process 600.

Process 600 begins, after a start block, at block 602, where a request from a carrier service is received for a best/optimal offer to be provided for a given customer. Flowing to block 604, information about the given customer may be received. Such information may include a unique identifier for the customer, as well as other information, including, but not limited to a channel or channels for which an offer might be presented; context-related attributes such as described above; as well as other information about the customer including historical data about the customer's purchasing history or the like. In one embodiment, where the customer has been previously identified, such historical data, and/or other attributes about the customer, such as described above, might be stored in a data stores. In which instance, the customer identifier might be used to receive or extract such customer information.

Processing then continues to block 606 where a determination is made whether the customer has been assigned a classification for a model for use in determining the optimal offer. If not, then the customer may be assigned to a model as described above. Otherwise, if the customer is assigned, such assignment is identified, such that proceeding to block 608; the model selected for the customer may be employed to determine the optimal offer. As noted, in one embodiment, best offers may be determined for a given model; however, in another embodiment, best offers from a plurality of different models might be compared to select a single best offer among best offers of the plurality of different models.

In any event, processing continues to block 610 where information about available offers is received. In one embodiment, such information may include the information described above, including, a name, description, start/end times, projected revenue and/or profits, and the like.

Continuing to block 612, various rules, parameters, weights, and/or other constraints are determined for the customer, offers, model, channel, carrier service, and the like. Flowing next to block 614, based on the constraints, customer information, selected model(s), and so forth, one or more available offers may be eliminated.

Processing continues to block 616, where a probability of acceptance may then be determined for each of the remaining offers using the model, constraints, customer information, and various input parameters, weights, and so forth.

Process 600 continues next to block 618, where a score is determined for each of the remaining offers using the probabilities of acceptance, the weights of the offers, the penalties, the projected revenues or profits, and so forth. One non-limiting, non-exhaustive example of a table that might be generated at block 618 is described above in conjunction with FIG. 5. Flowing next to block 620, an offer having the highest score is then sent to the carrier service in response to the received request, as being the optimal or best offer for the customer, given the model and provided inputs and constraints to the solution. In at least one embodiment, details of the offer may be retrieved from one or more data stores and provided to the carrier service. Processing then returns to a calling process to perform other actions.

Process 600 may be extended however, to manage tracking of a customer's purchase behavior based on being presented with the optimal offer. Thus, in one embodiment, a number of times that the offer is presented to the customer, which channel(s) the offer is presented to the customer, and information indicating whether the customer has selected to purchase a product and/or service described within the offer are tracked. Such information may then be used to update information about the customer to revise a determination of a probability of acceptance of a subsequent offer by the customer. For example, if the customer is determined to accept offers over one channel versus another channel, a probability of acceptance for subsequent offers might weight that particular channel higher than other channels. Moreover, based on other characteristics of the offer, such as whether the offer includes upgrades, new products, extended service coverage or the like, probabilities of acceptance for subsequent offers that have similar characteristics might be revised upwards. Such similarity in characteristics may be based on any of a variety of similarity metrics, including, but not limited, for example, cosine similarity metric, Tanimoto coefficient, or the like. Moreover, other information might be tracked including, but not limited to a frequency in which the offer was presented to the customer before being accepted, and/or whether the offer was ever accepted. If a customer specifically requested not to see the offer presentation again, such feedback may also be tracked, for use in modifying a probability of acceptance, a channel weighting, a frequency determination, and the like, for subsequent offers to this customer. Moreover, as noted, in at least one instance, an offer may be transformed into a physical purchase of a product and/or service by a customer, the purchase (and/or non-purchase) being subsequently tracked.

It will be understood that each block of the FIG. 6, and combinations of blocks in the illustration, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multi-processor computer system. In addition, one or more blocks or combinations of blocks in the illustration may also be performed concurrently with other blocks or combinations of blocks, or even in a different sequence than illustrated without departing from the scope or spirit of the invention.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, comprising:
receiving a request for an offer for a telecommunications product or service to be presented to a customer of a carrier service;
receiving information about a plurality of available offers, including at least one channel constraint on at least one of the available offers, or a predicted revenue for each available offer;
eliminating at least one available offer in the plurality of offers based on information about the customer;
determining a probability of acceptance of each remaining offer using predictive analytics to perform comparisons based at least in part on a customer attribute or a context of an offer;
determining scores for each of the remaining offers by employing a revenue and profitability maximization mechanism based in part on the probability of acceptance, customer context information, and the received information about each remaining offer; and
in response to the request, providing to the carrier service an offer having a highest score as being an optimal offer for the customer for a given channel in which the optimal offer is to be presented to the customer.

2. The network device of claim 1, wherein the predictive analytics is selected from one of a statistical regression model, decision tree, neural network, Bayesian classifier, graphical model, or survival model, pattern recognition.

3. The network device of claim 1, wherein determining scores further comprises employing at least one penalty for a given channel for each of the remaining offers in determining the scores for each of the remaining offers.

4. The network device of claim 1, wherein determining a probability of acceptance further comprises based in part on at least one customer attribute associated with a purchase history of the customer or a channel in which the best offer is to be presented to the customer.

5. The network device of claim 1, wherein the customer is assigned to a predictive model based on at least one of a random selection among different predictive models, or based on a characteristic of the customer.

6. The network device of claim 1, wherein a channel penalty is employed in determining scores for each of the remaining offers, wherein the channel penalty is configured as a channel specific time-based penalty that reflects at least a timing or frequency for which the provided optimal offer is to be presented to the customer.

7. A processor readable storage medium that includes data and instructions, wherein the execution of the instructions on a computing device by enabling actions, comprising:
receiving a request for an offer for a product or service to be presented to a customer of a merchant;
receiving information about a plurality of available offers, including at least one channel constraint, and a predicted revenue for each available offer;
determining a probability of acceptance of each offer using an analytical model to perform comparisons based at least in part on a customer attribute or a context of an offering;
employing the analytical model to determine scores for each of the offers by employing a revenue or profitability maximization mechanism based in part on the probability of acceptance, customer context information, and the received information about each remaining offer; and
in response to the request, providing an optimal offer to the merchant, wherein the optimal offer is that offer having a highest score, wherein the optimal offer is presented by the merchant to the customer using at least one channel that includes a display on a computer device or a physical paper presentation.

8. The processor readable storage medium of claim 7, wherein the analytical model is selected from one of a statistical regression model, decision tree, neural network, Bayesian classifier, graphical model, or survival model, pattern recognition.

9. The processor readable storage medium of claim 7, wherein determining scores further comprises employing at least one penalty for a given channel for each of the remaining offers in determining the scores for each of the remaining offers.

10. The processor readable storage medium of claim 7, wherein a channel penalty is employed in determining scores for each of the offers, wherein the channel penalty is configured as a channel specific time-based penalty that reflects at least a timing or frequency for which the provided optimal offer is to be presented to the customer.

11. The processor readable storage medium of claim 7, wherein determining scores for each of the offers further comprises eliminating at least one offer for which it is determined that the customer is ineligible.

12. The processor readable storage medium of claim 7, wherein the scores are further determined based on maximizing, for the merchant, a purchase likelihood by the customer for the product or service and further maximizing, for the merchant, a financial impact or benefit.

13. The processor readable storage medium of claim 7, wherein the analytical model further comprises selecting the analytical model based on a classification of the customer, wherein the customer is classification based on one of a random classification, or based on a characteristic of the customer.

14. A system for managing offers over a network, comprising:
a network device employed by a carrier service and configured to provide at least one product or service offer to a customer through at least one or a plurality of different channels, and to further perform actions, including
determining information about the customer, including a context for the customer, and an identifier of the customer;
sending a request for an optimal offer to be presented to the customer based on the customer identifier, context for the customer, and information about at least a subset of the plurality of different channels; and
another network device employed as a customer intelligence platform server that is configured to perform actions, including:
receiving the request for the optimal offer;
receiving information about a plurality of offers, including at least one channel constraint, and a predicted revenue for each offer;
determining a probability of acceptance of each offer using a model selected from at least one of a predictive or non-predictive model to perform comparisons based at least in part on a customer attribute or a context of an offering;
employing the selected model to determine scores for each of the offers by employing a revenue and profitability maximization mechanism based in part on the probability of acceptance, customer context information, and the received information about each remaining offer; and
providing the optimal offer to the network device, wherein the optimal offer is that offer having a highest score.

15. The system of claim 14, wherein the context for the customer comprises at least one of a location of the customer, a time of day, or a channel used by the customer to receive the offer.

16. The system of claim 14, wherein a channel specific time based penalty is employed to determine a frequency in which the optimal offer is to be presented to the customer for a given channel, wherein at least one channel is selected from one of a telephone conversation with the customer, a physical paper presentation to the customer, or a display on a screen of a client computer device.

17. The system of claim 14, wherein the customer is assigned to a model based on at least one of a random selection among different models, or based on a characteristic of the customer, the assigned model being the model selected to perform the comparisons.

18. The system of claim 14, wherein the optimal score is further determined based on maximizing the probability of acceptance while maximizing a financial impact or benefit to the carrier service.

19. The system of claim 14, wherein determining scores further comprises employing at least one penalty for a given channel for each of the offers in determining the scores for each of the offers.

20. The system of claim 14, wherein the probability of acceptance is determined based on a customer attribute that includes at least a purchasing history of the customer, and a channel history of the customer.
